(19) United States
(12) Patent Application Publication
(10) Pub. No.: US 2015/0200895 A1
(43) Pub. Date: Jul. 16, 2015

(54) MARKING OUTGOING COMMUNICATIONS FOR FOLLOW-UP

(71) Applicants: Yiyang Joy DING, Mountain View, CA (US); Alexander Collins, Mountain View, CA (US)

(72) Inventors: Yiyang Joy DING, Mountain View, CA (US); Alexander Collins, Mountain View, CA (US)

(73) Assignee: GOOGLE INC., Mountain View, CA (US)

(21) Appl. No.: 13/801,673

(22) Filed: Mar. 13, 2013

Related U.S. Application Data
(60) Provisional application No. 61/622,239, filed on Apr. 10, 2012.

(51) Int. Cl. H04L 12/58

(52) U.S. Cl. CPC H04L 51/22

(57) ABSTRACT

Responsiveness for outbound communications is monitored. An outbound communication initiated by a sender via a communications system is identified. Content of the outbound communication is analyzed to determine, using a processor of a computer, whether to monitor for a response to the outbound communication. Inbound communications to the sender are monitored for the response to the outbound communication, and a reminder is generated when a response to the outbound communication is not identified.

### PRIORITY

The present application claims priority under 35 U.S.C. §119(e) to U.S. Provisional Application 61/622,239, which was filed in the United States Patent and Trademark Office on Apr. 10, 2012, the entire contents of which are hereby incorporated by reference.

### BACKGROUND

Email interfaces sometimes store sent emails in a “sent” box. Emails in a sent box can be manually deleted or moved to another box by an owner of an email account that includes the sent box. Owners of email accounts may also be permitted to manually create and name their own boxes to help sort incoming and outgoing emails according to their own needs. Add-on software may be available to reconfigure an email account to mark outgoing emails for follow-up. The user activates the add-on software for individual outgoing emails to check for follow-up. Follow-up can be checked by either creating a calendar item in an associated calendar program to remind an owner to check for an expected response, or by monitoring an inbox for the email account and notifying the owner after a specified period or at a set date and time when no expected response is identified.

### SUMMARY OF THE DISCLOSURE

The present disclosure, through one or more of its various aspects, embodiments, and/or specific features or sub-components, provides various systems, servers, methods, media, and programs for interfacing compiled codes, such as, for example, JavaScript scripts.

According to an aspect of the present disclosure, a method is provided for monitoring responsiveness for outbound communications. The method includes identifying an outbound communication initiated by a sender via a communications system and analyzing content of the outbound communication to determine, using a processor of a computer, whether to monitor for a response to the outbound communication. The method also includes monitoring inbound communications to the sender for the response to the outbound communication, and generating a reminder when a response to the outbound communication is not identified.

According to another aspect of the present disclosure, the communications system comprises an email client.

According to yet another aspect of the present disclosure, the computer is an email server.

According to still another aspect of the present disclosure, the determining comprises analyzing content of the outbound communication and deciding based on the content that a response to the outbound communication is expected.

According to another aspect of the present disclosure, the analyzing is performed by executing an algorithm to recognize predetermined terminology.

According to yet another aspect of the present disclosure, the determining includes receiving a request from the sender to monitor for the response to the outbound communication.

According to still another aspect of the present disclosure, the determining is automatically performed before the outbound communication is sent.

According to another aspect of the present disclosure, the monitoring is performed for a period of time set by the sender.

According to yet another aspect of the present disclosure, the monitoring comprises setting a flag for the outbound communication, and receiving and recognizing the flag in the response.

According to still another aspect of the present disclosure, the monitoring comprises analyzing an inbound communication to determine whether the inbound communication is the response.

According to another aspect of the present disclosure, the reminder is provided as a new window identifying the outbound communication and indicating that an expected response has not been identified.

According to yet another aspect of the present disclosure, the reminder is provided as a new window identifying multiple outbound communications for which expected responses have not been identified.

According to still another aspect of the present disclosure, the new window is generated when the sender logs in to the communications system.

According to another aspect of the present disclosure, the determining is performed based on a selection from the sender to monitor for the response.

According to yet another aspect of the present disclosure, the method also includes providing a selectable option to the sender to specify whether to monitor for the response, and when to generate and provide the reminder when the response is not identified.

According to still another aspect of the present disclosure, the outbound communication is a response to an inbound communication.

According to another aspect of the present disclosure, the method also includes storing the outbound communication with a mark to indicate that a response is expected.

According to yet another aspect of the present disclosure, the method also includes storing the outbound communication in an area dedicated to outbound communications for which responses are expected.

According to an aspect of the present disclosure, a non-transitory computer readable medium stores a set of executable instructions for monitoring responsiveness for outbound communications. The executable instructions, when executed by a processor, cause a computer to identify an outbound communication initiated by a sender via a communications system and analyze content of the outbound communication to determine, using a processor of a computer, whether to monitor for a response to the outbound communication. The executable instructions also cause a computer to monitor inbound communications to the sender for the response to the outbound communication and generate a reminder when a response to the outbound communication is not identified.

According to an aspect of the present disclosure, a computer platform executes executable instructions for monitoring responsiveness for outbound communications. The computer platform includes memory and a processor. The processor executes the executable instructions, and the instructions, when executed, cause the computer platform to identify an outbound communication initiated by a sender via a communications system and analyze content of the outbound communication to determine, using a processor of a computer, whether to monitor for a response to the outbound communication. The instructions also cause the computer platform to monitor inbound communications to the sender for the response to the outbound communication and generate a reminder when a response to the outbound communication is not identified.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary system for a method for marking outgoing communications for follow-up, according to an aspect of the present disclosure;

FIG. 2 illustrates an exemplary network for a network for marking outgoing communications for follow-up, according to an aspect of the present disclosure;

FIG. 3 illustrates an exemplary user device and an exemplary server for marking outgoing communications for follow-up, according to an aspect of the present disclosure;

FIG. 4 illustrates an exemplary method for marking outgoing communications for follow-up, according to an aspect of the present disclosure;

FIG. 5 illustrates an exemplary user interface for marking outgoing communications for follow-up, according to an aspect of the present disclosure;

FIG. 6 illustrates another exemplary user interface for marking outgoing communications for follow-up, according to an aspect of the present disclosure;

FIG. 7 illustrates another exemplary user interface for marking outgoing communications for follow-up, according to an aspect of the present disclosure;

FIG. 8 illustrates another exemplary method for marking outgoing communications for follow-up, according to an aspect of the present disclosure;

FIG. 9 illustrates another exemplary method for marking outgoing communications for follow-up, according to an aspect of the present disclosure; and

FIG. 10 illustrates another exemplary user interface for marking outgoing communications for follow-up, according to an aspect of the present disclosure.

### DETAILED DESCRIPTION

The present disclosure, through one or more of its various aspects, embodiments and/or specific features or sub-components, is thus intended to bring out one or more of the advantages as specifically noted below.

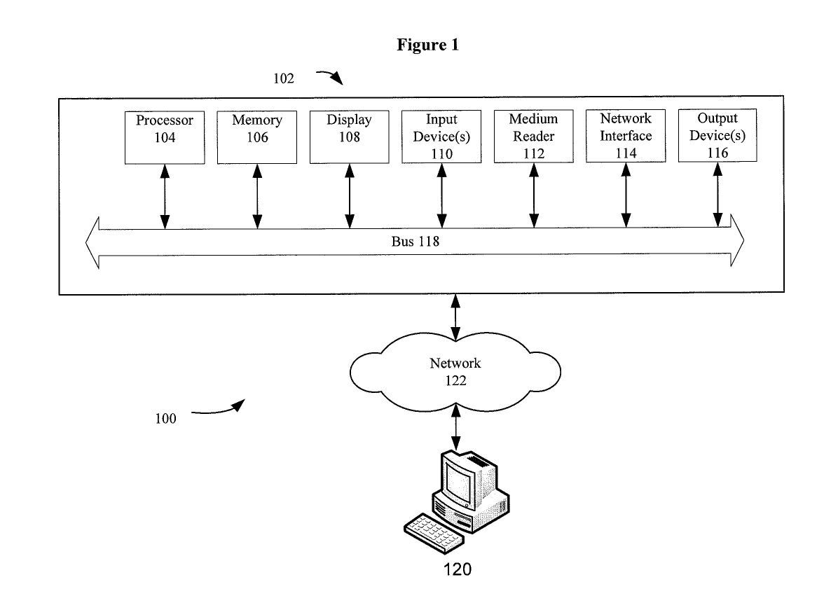

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or a cloud environment.

The computer system 102 may operate in the capacity of a server computer in a network environment, or in the capacity of a client user computer in the network environment. The computer system 102, or portions thereof, may be implemented as, or incorporated into, various devices, such as a server computer, a personal computer, a tablet computer, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of memories or a single storage.

As shown in FIG. 1, the computer system 102 may include a computer display 108, such as a liquid crystal display, an organic light emitting diode, a flat panel display, a solid state display, a cathode ray tube, a plasma display, or any other display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly understood as being included with or within a computer system, such as, but not limited to, an output device 116. The output device 116 may be, but is not limited to, a speaker, an audio out, a video output, a remote control output, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly understood such as, but not limited to, peripheral component interconnect, peripheral component interconnect express, parallel advanced technology attachment, serial advanced technology attachment, etc.

The computer system 102 may be in communication with one or more additional computer devices 120 via network 122. The network 122 may be, but is not limited to, one or more of a local area network, a wide area network, the Internet, a telephony network, or any other network commonly understood in the art. The network 122 shown in FIG. 1 may include both wireless and wired networks.

The additional computer device 120 is shown in FIG. 1 as a personal computer. However, those skilled in the art appreciate that, in alternative embodiments of the present application, the device 120 may be a server computer, a personal computer, a tablet computer, a personal digital assistant, a mobile device, a palmtop computer, a laptop computer, a desktop computer, a communications device, a wireless telephone, a personal trusted device, a web appliance, or any other device that is capable of executing a set of instructions (sequential or otherwise) that specify actions to be taken by that device. Of course, those skilled in the art appreciate that the above-listed devices are merely exemplary devices and that the device 120 may be any additional device or apparatus commonly understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive. Moreover, systems as described herein include one or more devices with the characteristics of the systems described herein along with any other consistent characteristics commonly understood to belong to such systems.

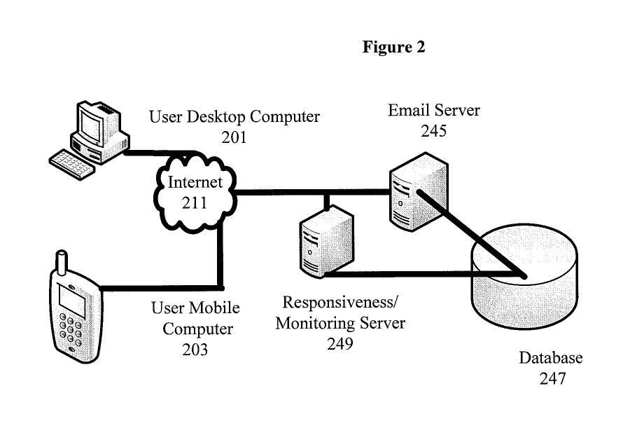

FIG. 2 illustrates an exemplary network for marking outgoing communications for follow-up, according to an aspect of the present disclosure. In FIG. 2, outgoing communications generated by a user system are analyzed to determine if a sender might expect a response from one or more recipients. If a determination is made that a response might be expected, the sender is requested to confirm the expectation of a response. Information of outgoing communications for which a response is expected are marked in a monitoring system to indicate, for example, the sender, the time frame by which responses are expected, and the recipients from whom responses are expected. A watermark or other types of data may also be inserted into an outgoing communication with the hope that an expected response will carry the watermark or other type of inserted data. Incoming communications to the sender are then monitored by the monitoring system to identify when expected responses are received. The information in the monitoring systems is updated when expected responses are identified, and senders are notified when expected responses are not identified within an expected timeframe. Reminders can then be sent from the senders to the recipients of the original outgoing communication from whom responses were expected but not received. The reminders to the original recipients can be auto-generated, or populated by the sender when the response expectations are confirmed, or populated at the time the sender is notified that response expectations have not been met. Reminders can even be sent automatically without further input from the sender when the initially confirms the response expectations. A reminder pre-populated by a sender might include text content such as “Hi! Did you have a chance to look at this yet?”

The outgoing communications that are generated, analyzed and marked, as well as the incoming communications that are monitored, may be emails, text messages, short message service (SMS) messages, instant messages, or other types of communications. Outgoing communications as described herein may include communications generated using accounts and sent from addresses not tied to a particular user system. An example of such an account and address is an email account with one or more email addresses that can be used by a user to send emails. The user may be able to send email from an email address using their email account on any system capable of supporting the email account. Outgoing communications as described herein may also include communications generated using accounts and sent from addresses tied to a particular user system. An example of such an account and address is a text message account with a single text address that can be used by a user to send text messages. The user may be required to send texts from the text address on only a single system such as a smart phone that is tied to the text address.

The analysis of outgoing communications described herein can be performed by sending user systems, intermediate network systems, and/or dedicated network systems. In FIG. 2, a sending user system is a user desktop computer 201, a user mobile computer 203 or the like. In FIG. 2, the desktop computer 201 and mobile computer 203 are merely exemplary of user systems of one or more devices that may support a communications account with communications addresses. In FIG. 2, an intermediate network system is an email server 245 or the like that intermediate communications between senders and recipients. The email server 245 intermediates mails sent to a user using an email client system on user desktop computer 201 or user mobile computer 203. Emails sent from the email client systems on user systems 201, 203 are sent to email server 245 or a similar server, and stored on or on behalf of email server 245 or the similar server. The email server 245 may store an email and attachments, or selected characteristics of the email and/or attachments, internally or in a database 247 or other memory.

In FIG. 2, a dedicated network system is a responsiveness/monitoring server 249 or the like that are peripheral to the intermediate network systems, but dedicated to performing services such as the analysis and monitoring described herein. Similarly, for the purpose of monitoring incoming communications to the sender, the responsiveness/monitoring server 249 may store an email and attachments, or selected characteristics of the email and/or attachments, internally or in a database 247 or other memory.

The monitoring described herein can be reliably performed by intermediate network systems, and/or dedicated network systems, but not by sending user systems in some cases. The monitoring cannot be reliably performed by sending user systems and the like when inbound communications may be received for the account on numerous different user systems. In other words, it may not be possible to accurately monitor all incoming communications to an account address using a particular sending user system when numerous different unsynchronized user systems used by the user can be used to access the account, receive inbound communications and in some instances delete the received communications. Deletions of such inbound communications by one user system may render impossible the ability of another user system to monitor the inbound communications to determine whether the inbound communications are an expected response. Accordingly, the monitoring of inbound communications may be reliably performed by a particular user system when the particular user system is the only user system that supports the account and address used to receive communications. On the other hand, the monitoring of inbound communications may be reliably performed only by an intermediate network system or a dedicated network system when the account and address used to send the outgoing communication can be supported on multiple user systems to receive incoming communications.

In FIG. 2, the user systems and other communications systems communicate over the Internet 211. The Internet 211 is merely exemplary of a communications network used to carry communications in FIG. 2. Communications networks used to communicate in FIG. 2 may include wired and wireless networks, local area networks and wide area networks, data and voice networks, and/or any other network commonly understood in the art to carry communications such as emails and text messages. In FIG. 2, communications such as emails and text messages are sent to one or more recipients via at least one or more intermediate network systems such as email server 245, and the networks over which the communications pass may include peripheral dedicated network systems such as responsiveness/monitoring server 249 that are used to implement selective peripheral services.

The analysis of outgoing communications from the account address can be performed by the sending user systems, the intermediate network systems, and/or the peripheral dedicated network systems described herein. The analysis of the outgoing communication may be performed either as the outgoing communication is drafted, after the sender authorizes sending the outgoing communication, or immediately after the outgoing communication is actually sent. The analysis includes analyzing information of the outgoing communication to determine if the sender might expect a response to the outgoing communication. When a determination is made that the sender might expect a response to the outgoing communication, the sender is asked to confirm that a response is expected. When the sender confirms a response is expected, the sender is asked to specify which recipients are expected to provide a response, and a timeframe in which the response is expected. A monitoring system then stores information reflecting that a response is expected for the outgoing communication, as well as the information provided by the sender as to who a response is expected from and the timeframe of when a response is expected.

When the analysis of the outgoing communication is performed as the outgoing communication is drafted, the analysis may be performed on the user systems 201, 203 as the outgoing communication is drafted. In the context of this discussion, the term “content” as applied to message analysis may include the body of a message and also the subject of the message. When analysis is performed on the user systems 201, 203, for example, recipients and content (e.g. message subject and message body) can be analyzed in real-time by an email client or messaging program on user systems 201, 203 to determine whether the sender might expect a response. When the analysis of the outgoing communication is performed after the sender authorizes sending the outgoing communication, the analysis may also be performed on the user systems 201, 203. For example, an email client or messaging program on user desktop computer 201 or user mobile computer 203 may analyze the entirety of an authorized email or message to determine whether the sender might expect a response. The email client or messaging program may generate a pop-up screen on the user desktop computer 201 or user mobile computer 203 to confirm whether the sender expects a response, and to solicit information of which recipients are expected to send a response and the timeframe in which a response is expected. When the analysis of the outgoing communication is performed immediately after the outgoing communication is actually sent, the analysis can still be performed on the user systems 201, 203 in the same manner as an analysis performed after the sender authorizes sending the outgoing communication.

When the analysis of the outgoing communication is performed as the outgoing communication is drafted, the analysis may also be performed on the intermediate network systems such as email server 245. In this example, the email server 245 can be repeatedly updated in real-time or near real-time by the user systems 201, 203 so as to perform the analysis. When the analysis of the outgoing communication is performed after the sender authorizes sending the outgoing communication, the analysis may also be performed on the intermediate network systems such as email server 245. For example, the intermediate network systems may analyze the entirety of the authorized email or message to determine whether the sender might expect a response. The intermediate network systems may then instruct the email client or messaging program on user systems 201, 203 to generate a pop-up screen to confirm whether the sender expects a response, and to solicit information of which recipients are expected to send a response and the timeframe in which a response is expected. When the analysis of the outgoing communication is performed immediately after the outgoing communication is actually sent, the analysis can still be performed on the intermediate network system 245 in the same manner as an analysis performed after the sender authorizes sending the outgoing communication, including instructing user systems 201, 203 to generate a pop-up screen to obtain information from the sender.

When the analysis of the outgoing communication is performed after the sender authorizes sending the outgoing communication, the analysis may also be performed on the dedicated network systems such as responsiveness/monitoring server 249. For example, the email server 245 may obtain the authorized email from the user system 201, 203, and forward the authorized email to responsiveness/monitoring server 249 for analysis. The responsiveness/monitoring server 249 may then analyze the entirety of the authorized email or message to determine whether the sender might expect a response. The dedicated network systems may then instruct the email client or messaging program, either directly or via the email server 245 indirectly, to generate a pop-up screen on the user desktop computer 201 or user mobile computer 203 to confirm whether the sender expects a response, and to solicit information of which recipients are expected to send a response and the timeframe in which a response is expected. When the analysis of the outgoing communication is performed immediately after the outgoing communication is actually sent, the analysis can still be performed on the dedicated network systems in the same manner as an analysis performed after the sender authorizes sending the outgoing communication, including instructing user systems 201, 203 either directly or indirectly to generate a pop-up screen to obtain information from the sender.

In FIG. 2, outbound communications for which expected responses are confirmed can then be marked before transmission to the recipients. For example, a watermark or embedded code such as a text character can be inserted into the communication, so that a “reply” email can then be identified as responsive to the original email. The marking of outbound communication also may not be a literal insertion of data into a communication. Marking can also be provided by simply storing sender and recipient information, time and date, and subject. Stored information can be searched and matched with information from incoming communications to the sender in order to determine when response expectations are satisfied. Using either inserted information or stored information, additional communications from the recipient(s) to the sender can be analyzed to see if they are the expected response to the marked outbound communication. Inserted data such as a watermark or embedded code may assist in identifying responsive communications, but are not absolutely required in identifying responsive communications. Responsive communications can be recognized by the sending address, the subject matter, the recipient address, and /or the content, in addition to the presence of inserted data when present. Other characteristics of incoming communications may also be analyzed to determine whether the communications satisfy response expectations. Additionally, communications to addresses of a sender other than the originating sending address of the account may be monitored when known in order to determine if responsive emails are sent to an alternative address of the sender.

The monitoring of incoming communications to the account and address used to send the outgoing communication may be performed by one or more intermediate network systems such as email server 245, and/or by one or more dedicated network systems such as responsiveness/monitoring server 249. Either type of monitoring system analyzes incoming communications to the sending user address, or another known address of the user, and searches for flags such as inserted data, and/or stored parameters of the earlier outbound communication such as recipient name and/or subject matter or sending date and time. The monitoring system may perform an initial analysis for the sender of an incoming communication, such as whether responses from such a sender is expected by a party for whom the monitoring is performed. The monitoring system may alternatively perform an initial analysis for the recipient of the incoming communication, such as whether the recipient of the incoming communication is expecting a response from anyone for earlier outgoing communications. In some circumstances, an initial negative conclusion for an initial analysis may result in no further analysis being performed, whereas a positive initial conclusion may result in additional checks being performed such as analysis of content to verify that an incoming communication satisfies a response expectation for a recipient.

As recipients of communications log into their accounts, their waiting incoming emails are pushed from the intermediate network systems such as email server 245 or similar server to the user system(s) 201, 203 by which the recipients log into their email accounts. The intermediate network system becomes aware that the recipients log into their recipient accounts on user systems, and forward communications that were waiting for the recipients to log in to their recipient addresses. These forwarded communications can be analyzed to check for matches either as received by the intermediate network systems, or after the original senders log into their accounts and the communications are forwarded to the original senders.

If the recipients are logged in to their accounts already when the incoming communications are initially sent, the incoming communications may be received by the recipients in real time or near real time as the intermediate network system such as email server 245 or similar server recognizes that the recipients are available to receive the incoming communications. Some user systems such as smart phones may be logged in to an account even when the user is not actively using or monitoring the user systems, so that communications sent to recipients logged into accounts on the smart phones are always or frequently received in real time or near real time. An example is a user that leaves an email client program open on a personal computer in the background, so received emails are automatically forwarded to the personal computer and the user is notified of the new email. Additionally, some user systems such as smart phones may notify users with an alert tone or other designated signal when new emails or text messages are available for retrieval. The user can then activate the email client or message program on such a user system and retrieve and review the email or message. In any circumstance described above, a monitoring analysis by the intermediate network system or dedicated network system can be performed at any time between when the incoming communications are received and when the incoming communications are deleted by the original sender from user systems 201, 203 or other receiving user system.

In FIG. 2, a responsiveness/monitoring server 249 is shown separately from the exemplary email server 245 described above. However, instead of responsiveness/monitoring server 249, an exemplary email server 245 may include the characteristics of the responsiveness/monitoring server 249 described herein. In other words, analysis and monitoring of received communications as described herein may be performed by existing intermediate network systems or appropriate replacement systems improved to perform the analysis and monitoring of incoming communications as described herein, without requiring entirely new and additional dedicated equipment.

The responsiveness/monitoring server 249 may be notified by intermediate network systems of responses expected by the initial senders from communications sent from the desktop computer 201 or mobile computer 203. As noted herein, the intermediate communications systems in a network may pass monitoring and analysis responsibilities off to peripheral dedicated systems so that the intermediate communications systems can be dedicated to efficiently routing communications through the network. Either the intermediate network systems or the dedicated network systems may perform the initial analysis described herein for outgoing communications, and determine when the user expects a response to an outgoing email or text or other communication. Either the intermediate network systems or the dedicated network systems in FIG. 2 can also monitor and analyze inbound communications to determine when response expectations are satisfied.

The process of confirming that a response is expected can be initiated by the responsiveness/monitoring server 249 by directly or indirectly communicating with the user systems 201, 203. The process of confirming that a response is expected can also be initiated by the email server 245 by directly communicating with the user systems 201, 203. The process if confirming that a response is expected can also be initiated by the user systems 201, 203 if the analysis of outgoing communications is performed by the user systems 201, 203. The process may involve generating pop-up windows or other notable visual prompts to alert the user that input is requested. The user may initially be asked to confirm that a response is expected, and if so may be asked to specify recipients and deadlines for expected responses.

In the embodiment of FIG. 2, an email generated by a user is analyzed either as the email is drafted, or upon the user authorizing sending of the email, or immediately after the user sends the email such as when an email server 245 or responsiveness/monitoring server 249 becomes aware of the email being generated or authorized or sent. The analysis may be performed by the email client on the user desktop computer 201 or user mobile computer 203, or by email server 245 or responsiveness/monitoring server 249. A determination that a response is requested then leads to the intermediate network system or the dedicated network system analyzing and monitoring incoming communications, depending on which type of system is responsible for such monitoring and analysis of incoming communications.

The analysis of outgoing communications includes an algorithm of systematically checking parameters and data of the outgoing communication, such as phrases and individual words in the body of the communication, recipients of the communication, a relationship between the sender and recipients, a domain of the sender, whether the outgoing communications is itself a responsive communication or forwarded communication, the presence and nature of attachments, and/or specific flags or insertions set by the sender to identify the communication as one for which a response is expected. Any positive determination from this analysis will result in either incoming communications to the sending address being automatically monitored to determine whether they are follow-ups, or in the user being presented with an option to confirm that the incoming communications should be monitored for follow-up.

An example of analysis would be identifying a phrase such as “Let me know” in the body of an email. Another example would be identifying an email with the term “Please” in an email from a Supervisor to recipients that are known underlings. In this regard, an analysis system may be provided an organizational chart so as to ensure relationships between senders and recipients are known. Additionally, an analysis might identify terms such as “still waiting” as communications that are themselves reminding recipients of responses that were already expected. Even identification of a reminder from a sender may allow the sender to set a timeframe by which a response to the reminder is expected.

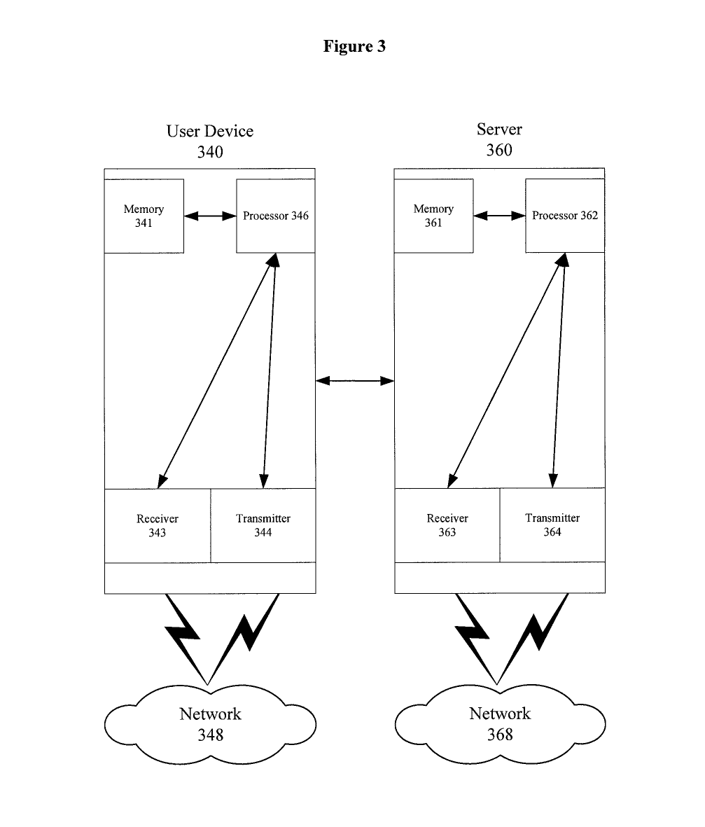

FIG. 3 illustrates an exemplary user device and an exemplary server for marking outgoing communications for follow-up, according to an aspect of the present disclosure. In FIG. 3, a user device 340 is a device of a user system described herein, and server 360 is a server of the intermediate network system or the dedicated network system described herein. Each of the user device 340 and the server 360 include memory, a processor, a receiver and a transmitter, and each communicated over a network. User device 340 includes memory 341, a processor 346, a receiver 343 and a transmitter 344. Server 360 includes memory 360, a processor 362, a receiver 363, and a transmitter 364. User device 340 communicates over network 348, and interacts with server 360 either directly or over a network (not shown). Server 360 communicates over network 368, and interacts with user device 340 either directly or over a network (not shown). Each of the user device 340 and the server 360 is instantiated on a tangible physical machine that stores data such as instructions in memory 341, 361 and executes instructions with processors 346, 362.

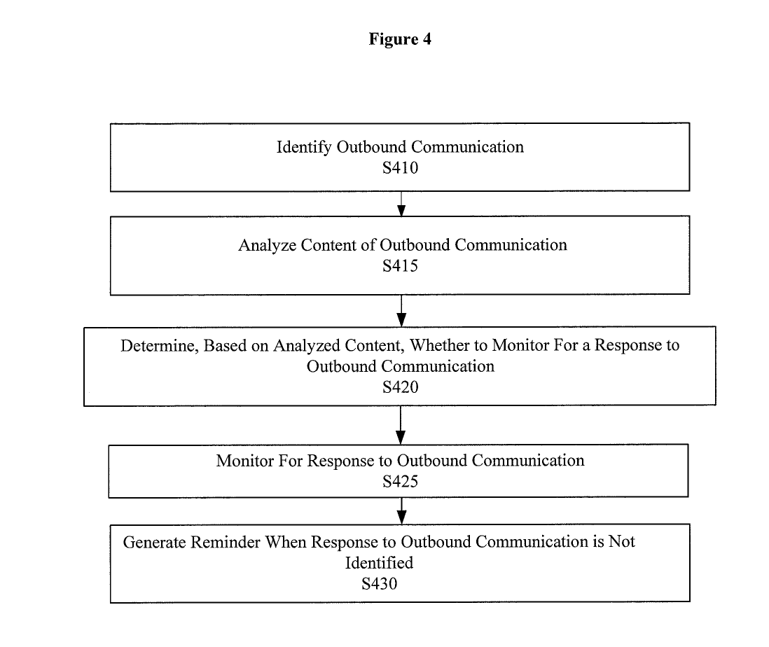

FIG. 4 illustrates an exemplary method for marking outgoing communications for follow-up, according to an aspect of the present disclosure. In FIG. 4, an outbound communication is identified at S410. Content of the outbound communication is analyzed at S415. At S420, an analysis determines, based on analyzed content, whether to monitor for a response to the outbound communication. At S425, incoming communications are monitored for a response to the earlier outbound communication. At 5430, a reminder is generated when a response to an outbound communication is not identified. Of course, if a response to the outbound communication is identified, the monitoring for such a response is stopped and the stored parameters that are being used to identify a response may be deleted from the monitoring system such as the intermediate network system or the dedicated network system.

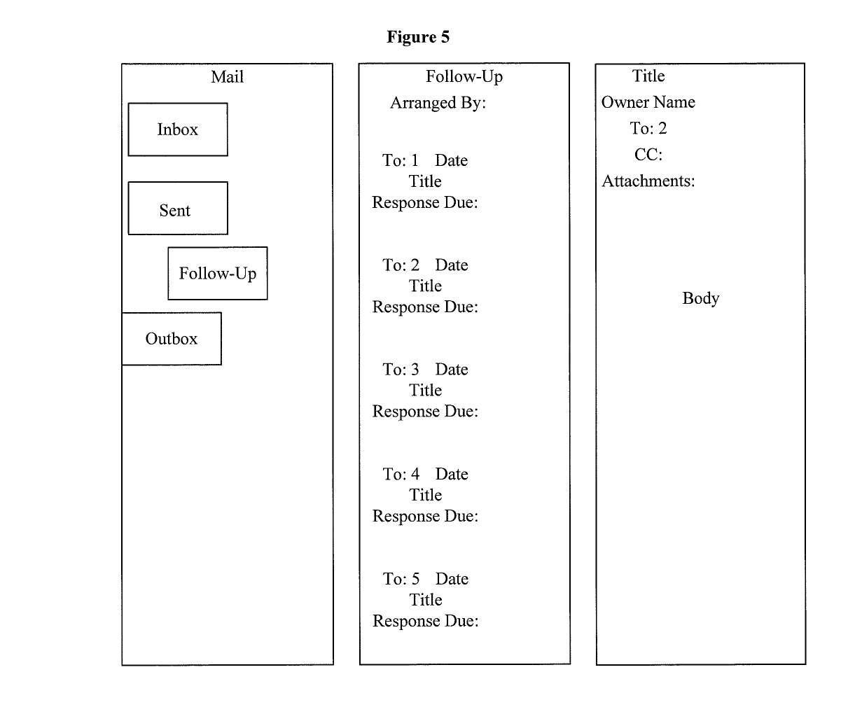

FIG. 5 illustrates an exemplary user interface for marking outgoing communications for follow-up, according to an aspect of the present disclosure. In FIG. 5, a left pane of a user interface is marked “Mail” an includes an inbox tab, a sent tab, an outbox tab, and a follow-up tab under the sent tab. The follow-up tab may be a selectable and expandable link that, when selected, opens up the middle pane to show follow up communications for which responses are still expected. In the middle pane of FIG. 5, the follow up folder or box or other arrangement of information include five separate outgoing communications that were already sent, along with their dates, their Titles and the response due dates/times. In FIG. 5, the right pane shows the second follow up communication from the follow up folder, and includes the Title, the owner name, the recipient, any copied recipients, attachment listings, and the content of the sent communication. The user interface in FIG. 5 would be provided on a user system 201, 203 in FIG. 2, and represents a logical arrangement of a user's outgoing communications for which responses may be expected.

In an embodiment, a sender may not require a time period for response, and may instead wish to merely monitor a sent email in a follow-up folder as shown in FIG. 5. In this example, either no “Response Due” is shown for the email being stored for monitoring, or the “Response Due” label is shown but left blank. In FIG. 5, the middle pane of expected responses may also be sortable by recipient, date/time sent, most overdue or other parameters that can help a sender organize communications in a folder. Another alternative would be to have only the “Sent” folder in the left pane of FIG. 5 without the “Follow-up” folder, and then label individual emails to indicate that responses are expected for the email Additionally, response expectations can be escalated when multiple reminders have been sent, or when predetermined threshold timeframes are exceeded.

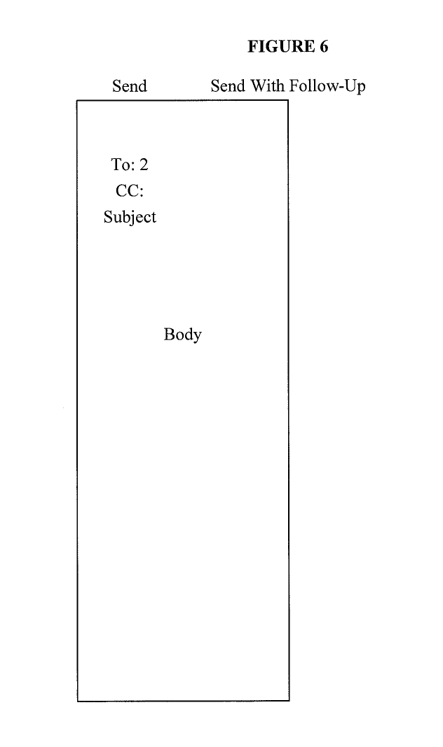

FIG. 6 illustrates another exemplary user interface for marking outgoing communications for follow-up, according to an aspect of the present disclosure. In FIG. 6, an outgoing communication is shown in the process of being generated. In this Figure, two selectable options above the pane indicate that the user can send the communication or the user can send the communication with a follow-up requirement. When the sender affirmatively selects to send a communication with follow-up, the analysis described herein for the outgoing communication may not be necessary, as the user may affirmatively indicate that follow-up is requested before such an analysis is performed. Even when sending with a follow-up requirement or request is not provided as an affirmative selectable option, a user may be provided an ability to insert data such as a watermark or code into an outgoing communication, and the inserted data can be used to trigger the monitoring for a response. In the event that a user inserts an indication that a response is expected, the confirmations described herein may not be performed, and default settings of expectations may be used such as that all recipients are expected to respond by the close of business or within a predetermined number of days. Of course, the entire outgoing communication shown in FIG. 6 can also be analyzed as described herein, so that a user is only selectively requested to confirm that a response is expected when the analysis determines that a response is requested.

An example of a user using the user interface of FIG. 6 would be a supervisor that requires a response from an underling in order to update a task list. The supervisor drafts an email, hits the “Send with Follow-up” button, populates the pop-up dialogue with recipient and time limit, and sends the email. At the time limit, when no response is received, the supervisor may be alerted to send a reminder to the underling. Several modifications to embodiments described herein are readily described in relation to FIG. 6. For example, instead of a dedicated button for “Send with Follow-up”, the user interface may have a checkbox that can be checked by a sender for “Remind to Follow-up”. Additionally, instead of a pop-up reminder to the sender when a time limit is reached without an expected response, the reminder may be the original sent email being surfaced in a “Follow-up” inbox. Reminders may be provided when sent emails are not read by recipients in addition to when recipients do not provide an expected response.

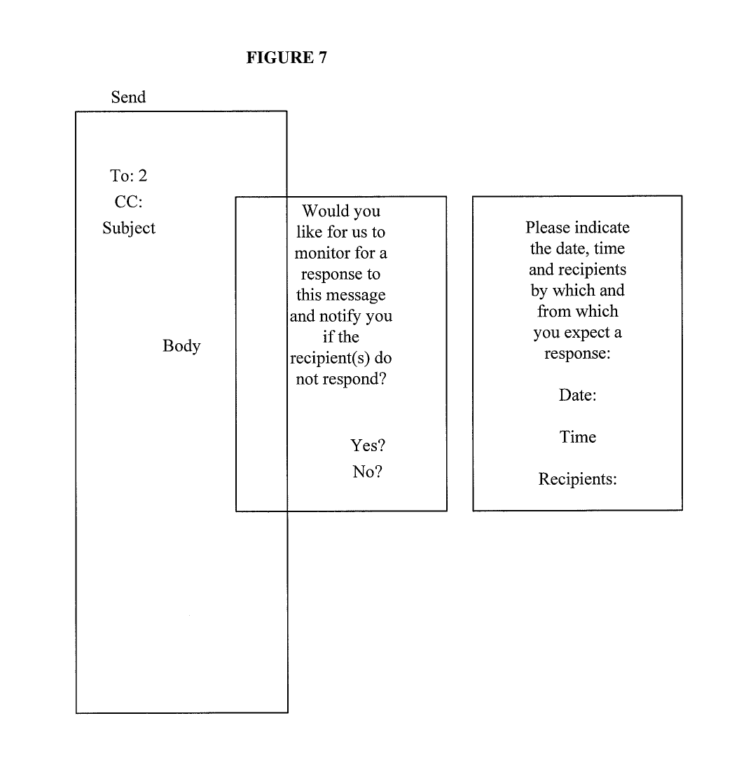

FIG. 7 illustrates another exemplary user interface for marking outgoing communications for follow-up, according to an aspect of the present disclosure. In FIG. 7, a middle pane shows a pop-up window that pops up for an email to request confirmation that a response is expected. If the user selects “yes” to indicate that a response is expected, a second pop-up window on the right allows the user/sender to indicate the date/time by which a response is expected, and recipients from whom a response is expected.

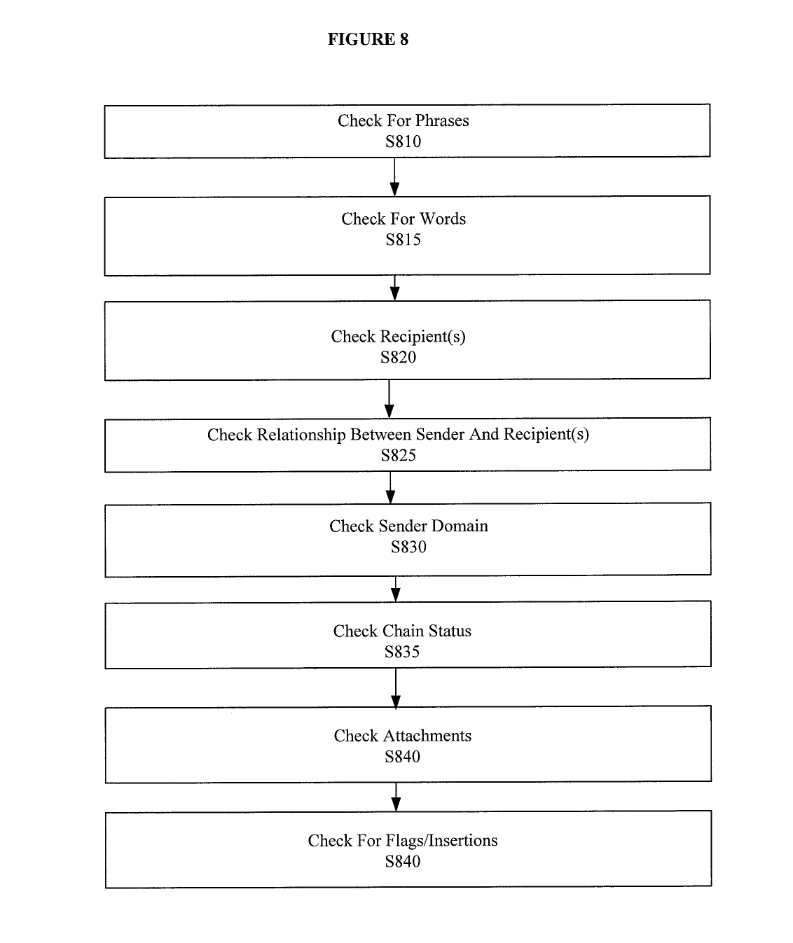

FIG. 8 illustrates another exemplary method for marking outgoing communications for follow-up, according to an aspect of the present disclosure. In FIG. 8, a systematic algorithm checks for numerous parameters of an outgoing communication to determine whether a response might be expected. In FIG. 8, phrases are checked for at S810, words are checked for at S815, recipients are checked for at S820, a relationship between the sender and recipients is checked for at S825, a sender domain is checked at S830, a chain status of the outgoing communication is checked at S835, and attachments are checked at S840, and flags/insertions are checked at S840. Each of the checks in FIG. 8 may be performed using a subroutine to check content and parameters of the outgoing communication against known listed content and parameters.

In an embodiment, the user may list content and parameters for outgoing communications for which responses are expected by default. Default settings may be set by a user for communications to subordinates, or contractors, or children or others from whom responses are normally expected.

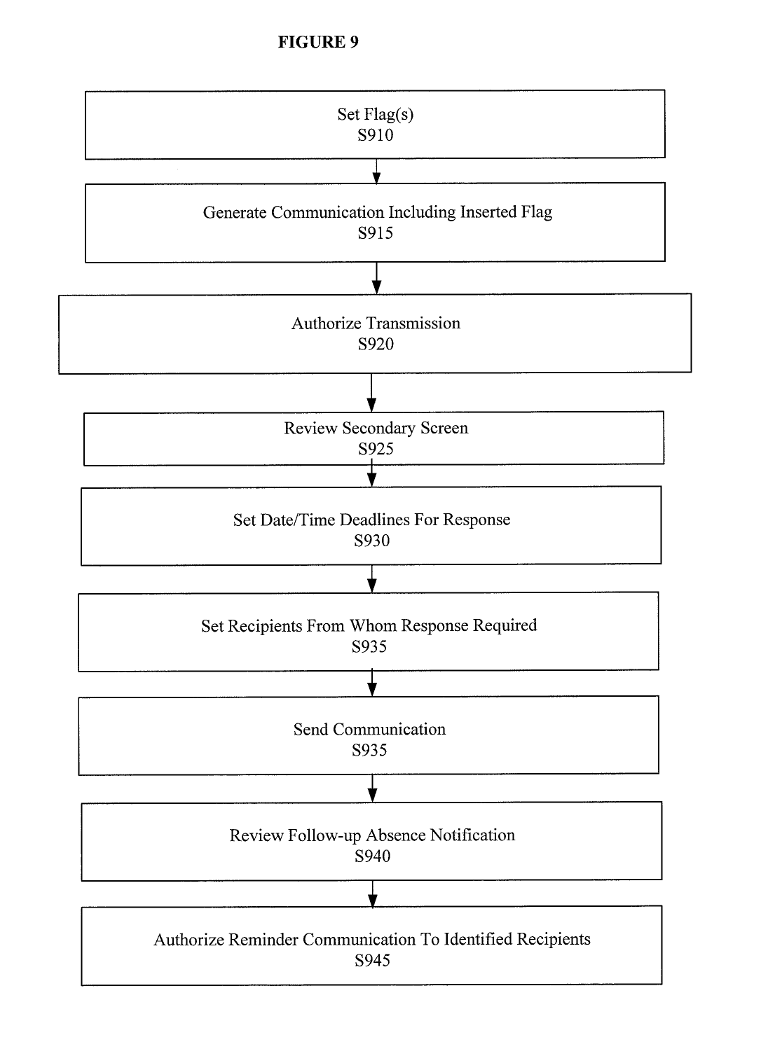

FIG. 9 illustrates another exemplary method for marking outgoing communications for follow-up, according to an aspect of the present disclosure. In FIG. 9, flags are set at S910. A communications including an inserted flag is generated at S915. At S920, transmission is authorized, and at S925 a secondary screen such as a pop-up is reviewed. At S930, a date and time deadline for response is set, and at S935, individual recipients of the communication from whom responses are expected are selected. At S935, communications are sent, and at S940, a follow-up absence notification is reviewed. At S945, the sender authorizes a reminder to identified recipients. The method of FIG. 9 may represent all or even more than all of the functions required from a user, as analysis and monitoring are performed normally by internal network systems such as the intermediate network system or the dedicated network system described herein.

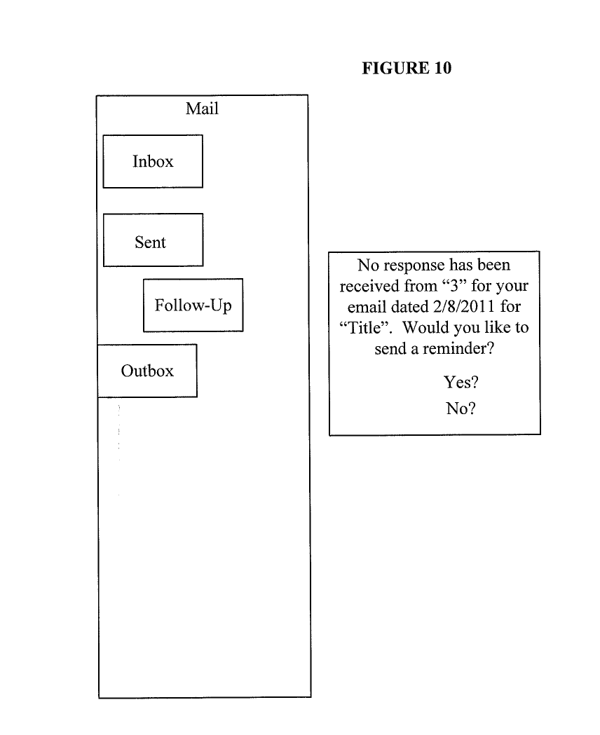

FIG. 10 illustrates another exemplary user interface for marking outgoing communications for follow-up, according to an aspect of the present disclosure. In FIG. 10, a notification is provided to a sender as a pop-up to indicate that a response has not been received for an earlier email on a given date and with a given Title. The sender is asked whether a reminder should be sent.

As described herein, outgoing communications are generated by a user system. The outgoing communications are analyzed to determine if a sender might expect a response from one or more recipients. If a determination is made that a response might be expected, the sender is requested to confirm the expectation of a response. Information of outgoing communications for which a response is expected are marked in a monitoring system to indicate, for example, the sender, the time frame by which responses are expected, and the recipients from whom responses are expected. A watermark or other types of data may also be inserted into an outgoing communication with the hope that an expected response will carry the watermark or other type of inserted data. Incoming communications to the sender are then monitored by the monitoring system to identify when expected responses are received. The monitoring system is an internal network component such as an intermediate network system or a dedicated peripheral network system. The information in the monitoring systems is updated when expected responses are identified, and senders are notified when expected responses are not identified within an expected timeframe. Reminders can then be sent from the senders to the recipients of the original outgoing communication from whom responses were expected but not received.

Emails are traditionally understood to be generated by a user typing on a keyboard or a virtual keyboard and typing in recipient email addresses or selecting email addresses from a contact list. Emails may, however, be generated by voice instructions and converted to text data either by a voice-to-text program on a user system or on a conversion program on a network system that receives the voice instructions and content from the user and converts the voice instructions to text data. In either type of conversion from voice to text, the converted email and any attachments are sent to recipients either logged into their email accounts or as they log in to their email accounts.

Additionally, while the present disclosure describes the ability of a user to insert data into an outgoing communication in order to trigger the follow-up service activation, a user may also be able to turn the follow-up analysis off. The follow-up service can be turned on and off email by email if the service is invoked in this manner.

Accordingly, the present disclosure provides various systems, servers, methods, media, and programs for generating a graphical comparison of data files. Although this disclosure refers to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A system including:
a processor; and
a processor-readable memory having instructions stored thereon which, when executed by the processor, cause the processor to carry out a method of monitoring responsiveness for outbound communications, the method comprising
identifying an outbound communication initiated by a sender via a communications system;
analyzing a content of the identified outbound communication, where content includes a message body and a message subject of the identified outbound communication;
determining, based on a result of said analyzing, whether a response is expected to the identified outbound communication;
in response to a determination that a response is expected, monitoring inbound communications to the sender via the communications system for a certain time period to detect the expected response to the outbound communication; and
in response to an indication that the expected response was not detected within the certain time period during said monitoring, generating a reminder indicating that the expected response has not yet been received by the communications system.

2. The system of claim 1, the method further comprising analyzing information about one or more recipients of the identified outbound communication; and
the step of determining further including determining, based on a result of analyzing the content and based on a result of analyzing information about one or more recipients, whether a response is expected to the identified outbound communication.

3. The system of claim 1, the step analyzing the content of the identified outbound communication including executing a processor-implemented algorithm to recognize predetermined terminology within the content.

4. The system of claim 1, the method further comprising establishing the certain time period based on a result of analyzing the content.

5. The system of claim 1, the method further comprising providing a selectable option to the sender to specify whether to monitor for an expected response;
and determining that a response is not expected to the identified outbound communication in response a selection by the sender specifying not to monitor for the expected response.

6. The system of claim 1, the method further comprising analyzing information about one or more recipients of the identified outbound communication; and
the step of analyzing a content of the identified outbound communication includes analyzing the content of the identified outbound communication based on a result of analyzing information about one or more recipients.

7. The system of claim 1, wherein the certain time period is established by the sender.

8. The system of claim 3, the algorithm being configured to identify a requested response date in the content; and
the method further comprising establishing the certain time period based on the identified requested response date.

9. The system of claim 1, the step of monitoring further comprising:
setting a flag for the identified outbound communication; and
recognizing the set flag in the expected response.

10. The system of claim 1, the step of monitoring including:
analyzing an inbound communication to the sender via the communications system; and
determining, based on an outcome of said analyzing, whether the inbound communication is the expected response.

11. The system of claim 1, wherein the reminder is provided as a new window identifying the outbound communication and indicating that an expected response has not been identified.

12. The system of claim 1, the step of generating a reminder including:
on an information display that enables the sender to interact with the communications system, presenting a window that includes therein information about one or more previously sent outbound communications for which an expected response has not been received.

13. The system of claim 12, the step of presenting being performed in response to a successful log-in event associated with the sender's account in the communications system.

14. The system of claim 1, wherein the identified outbound communication is a response to an inbound communication.

15. The system of claim 1, the method further comprising:
storing the identified outbound communication along with indication data to indicate that a response to the identified outbound communication is expected.

16. The system of claim 1, the step of determining being performed by the processor before the identified outbound communication is sent via the communications system.

17. The system of claim 1, wherein the communications system comprises an email client.

18. The system of claim 1, wherein the processor is included in an email server.

19. A non-transitory computer readable medium that stores a set of executable instructions for monitoring responsiveness for outbound communications, the executable instructions, when executed by a processor, cause the processor to carry out a method of monitoring responsiveness for outbound communications, the method comprising the steps of:
identifying an outbound communication initiated by a sender via a communications system;
analyzing a content of the identified outbound communication;
determining, based on a result of said analyzing, whether to monitor inbound communications to the sender for an expected response to the identified outbound communication;
in response to a determination to monitor inbound communications, monitoring inbound communications to the sender via the communications system for a predetermined time period to detect the expected response to the outbound communication; and
in response to an indication that the expected response was not detected within the predetermined time period during said monitoring, generating a reminder indicating that the expected response has not yet been received by the communications system.

20. A method of monitoring responsiveness for outbound communications, the method comprising the steps of:
identifying an outbound communication initiated by a sender via a communications system;
analyzing a content of the identified outbound communication with the communications system;
determining, based on a result of said analyzing, whether to monitor inbound communications to the sender for an expected response to the identified outbound communication;
in response to a determination to monitor inbound communications, monitoring, with the communications system, inbound communications to the sender for a predetermined time period to detect the expected response to the outbound communication; and
in response to an indication that the expected response was not detected within the predetermined time period during said monitoring, generating a reminder, with the communications system, indicating that the expected response has not yet been received by the communications system.
